(19) United States
(12) Patent Application Publication
(10) Pub. No.: US 2020/0164477 A1
(43) Pub. Date: May 28, 2020

(54) MACHINE TOOL

(71) Applicant: Fanuc Corporation, Yamanashi (JP)

(72) Inventor: Gaku ISOBE, Yamanashi (JP)

(73) Assignee: Fanuc Corporation, Yamanashi (JP)

(21) Appl. No.: 16/655,505

(22) Filed: Oct. 17, 2019

(30) Foreign Application Priority Data
Nov. 26, 2018 (JP) 2018-220091

(51) Int. Cl. B23Q 15/12; F16C 19/52; B23Q 17/00

(52) U.S. Cl. CPC B23Q 15/12; B23Q 17/007; F16C 19/522

(57) ABSTRACT

Provided is a machine tool including: a main shaft; feed-axis motors that relatively move a table and the main shaft in directions intersecting the longitudinal axis of the main shaft; feed-load measurement units that measure the magnitudes of loads applied to the feed-axis motors; and an anomaly detection unit that detects abnormal loads on the feed-axis motors when the magnitudes of the loads measured by the feed-load measurement units are greater than a predetermined threshold, wherein the predetermined threshold is changed according to the length of a tool that is held by the main shaft.

### CROSS-REFERENCE TO RELATED APPLICATIONS

This application is based on Japanese Patent Application No. 2018-220091, the contents of which are incorporated herein by reference.

### TECHNICAL FIELD

The present invention relates to a machine tool and particularly to a machine tool that has a function for detecting an abnormal load on a feed-axis motor.

### BACKGROUND ART

In the related art, there is a known device in which a function for detecting an abnormal load on a shaft rotation motor has been installed (for example, see PTL 1 to PTL 4). In PTL 1 to PTL 4, the load torque of a motor is monitored, and, when the load torque exceeds a predetermined threshold, it is determined that an abnormal load is applied to the motor, and the speed of the motor is reduced or the motor is stopped.

On the other hand, a feed-axis motor that relatively moves a workpiece and a tool is provided in a machine tool for performing milling etc. Many machine tools have a function for monitoring the load on the feed-axis motor and notifying an operator of an abnormal load when the load exceeds a threshold. During machining of a workpiece by using a distal-end section of the tool, a large load is applied to a main shaft that holds a proximal-end section of the tool. By detecting an abnormal load on the feed-axis motor, it is possible to take an avoidance action, e.g., to stop the feed-axis motor and the main-shaft motor, for avoiding damage to the main shaft and parts around the main shaft.

### CITATION LIST

### Patent Literature

{PTL 1} Japanese Unexamined Patent Application, Publication No. 2013-252576
{PTL 2} Japanese Unexamined Patent Application, Publication No. 2006-011122
{PTL 3} Japanese Unexamined Patent Application, Publication No. 2016-153683
{PTL 4} Japanese Unexamined Patent Application, Publication No. 2017-171452

### SUMMARY OF INVENTION

According to one aspect, the present invention provides a machine tool including: a main shaft that holds a tool; a feed-axis motor that relatively moves a table to which a workpiece is fixed and the main shaft, in a direction intersecting the longitudinal axis of the main shaft; a feed-load measurement unit that measures the magnitude of a load applied to the feed-axis motor; and an anomaly detection unit that detects an abnormal load on the feed-axis motor when the magnitude of the load measured by the feed-load measurement unit is greater than a predetermined threshold, wherein the predetermined threshold is changed according to the length of a tool that is held by the main shaft.

### BRIEF DESCRIPTION OF DRAWINGS

FIG. 1 is an outline front view of a machine tool according to one embodiment of the present invention.

FIG. 2 is an outline side view of the machine tool shown in FIG. 1.

FIG. 3 is a block diagram of the machine tool shown in FIG. 1.

FIG. 4 is a view showing a correspondence table stored in a storage unit.

FIG. 5 is a flowchart for explaining the operation of the machine tool shown in FIG. 1.

FIG. 6 is an outline longitudinal sectional view of a main shaft and a main-shaft head.

FIG. 7 is a view for explaining design values related to a tool and bearing parts of the main shaft.

FIG. 8 is a view showing a modification of the correspondence table shown in FIG. 4.

FIG. 9 is a view showing another modification of the correspondence table shown in FIG. 4.

FIG. 10 is a view showing still another modification of the correspondence table shown in FIG. 4.

### DESCRIPTION OF EMBODIMENTS

A machine tool 1 according to one embodiment of the present invention will be described below with reference to the drawings.

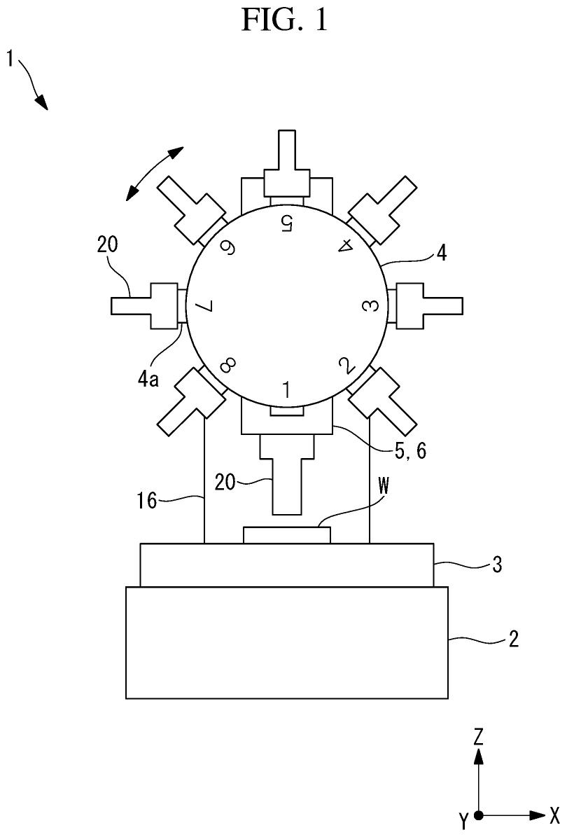

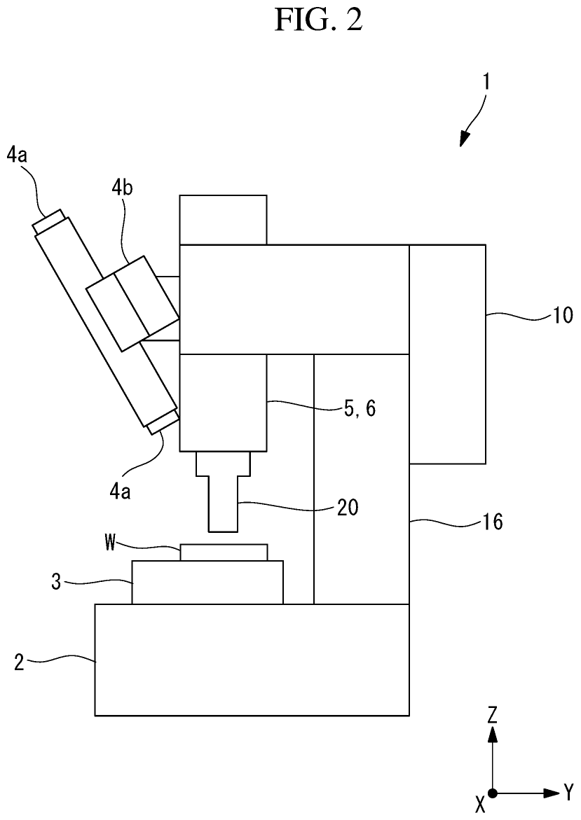

As shown in FIGS. 1 to 3, the machine tool 1 of this embodiment is provided with: a bed 2; a table 3 to which a workpiece W is fixed; a tool magazine 4 that holds a plurality of tools 20; a main shaft 5 that selectively holds one of the plurality of tools 20; a main-shaft head 6 that supports the main shaft 5; a main-shaft motor 7 that rotates the main shaft 5; feed-axis motors 8X, 8Y, and 8Z that relatively move the table 3 and the main shaft 5; feed-load measurement units 9X and 9Y that measure the magnitudes of loads on the feed-axis motors 8X and 8Y; and a control device 10 that controls the tool magazine 4 and the motors 7, 8X, 8Y, and 8Z.

In the following explanation, the X-direction and the Y-direction are horizontal directions perpendicular to each other, and the Z-direction is a vertical direction.

The bed 2 is installed at a place where the machine tool 1 is used, by using, for example, leveling bolts. An X-axis rail (not shown) that extends in the X-direction and a Y-axis rail (not shown) that extends in the Y-direction are fixed to the bed 2.

The table 3 is disposed on the bed 2 and is movable in the X-direction and the Y-direction along the X-axis rail and the Y-axis rail, with respect to the bed 2. The workpiece W is disposed on a top surface of the table 3 and is fixed to the table 3 by using an arbitrary fixing means. A column 16 that is fixed to the bed 2 and that extends upward from the bed 2 in the Z-direction is provided close to a rear surface of the table 3. The main-shaft head 6, the main-shaft motor 7, and the tool magazine 4 are supported by an upper-end section of the column 16.

The tool magazine 4 is a disk-like member and is supported by the upper-end section of the column 16 so as to be rotatable about a central axis of the tool magazine 4. The tool magazine 4 has a plurality of tool holding parts 4a arranged at intervals in the circumferential direction, and each of the tool holding parts 4a holds a tool 20. The respective tool holding parts 4a have identification numbers 1, 2, 3, . . . , and 8 assigned thereto. When a rotation motor 4b rotates the tool magazine 4 in response to a control signal from the control device 10, one of the plurality of tools 20, which are held by the plurality of tool holding parts 4a, is selectively positioned at a tool replacement position in the vicinity of the main-shaft head 6. At the tool replacement position, one of the tools 20 is exchanged between the corresponding tool holding part 4a and the main shaft 5, to perform replacement of the tool 20 that is held by the main shaft 5.

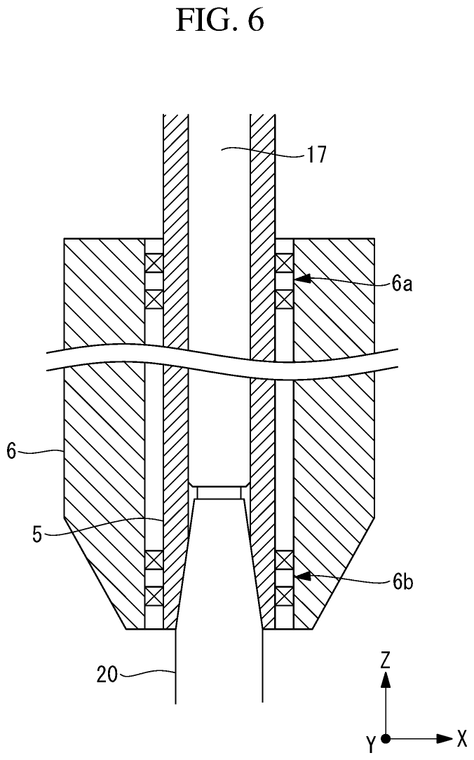

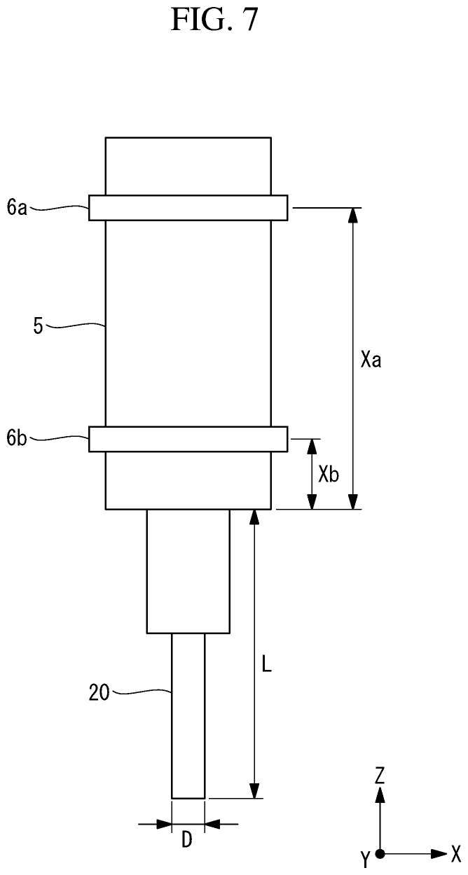

The main-shaft head 6 and the main shaft 5 are disposed above the table 3. A Z-axis rail (not shown) that extends in the Z-direction is fixed to the upper-end section of the column 16. The main-shaft head 6 is a member formed in a shape that has a cylindrical section extending along the Z-direction and is movable in the Z-direction along the Z-axis rail. The main shaft 5 is disposed inside the main-shaft head 6 along the Z-direction. The main-shaft head 6 is provided with bearing parts 6a and 6b (see FIGS. 6 and 7) that support the main shaft 5 in a manner allowing the main shaft 5 to rotate about the longitudinal axis of the main shaft 5. The main shaft 5 detachably holds a proximal-end section of one of the tools 20. The main-shaft motor 7 is connected to a proximal-end section (upper-end section) of the main shaft 5. The main-shaft motor 7 is a spindle motor for rotating the main shaft 5 about the longitudinal axis of the main shaft 5.

The feed-axis motors are formed of: the X-axis motor 8X and the Y-axis motor 8Y, which move the table 3 in the X-direction and the Y-direction, respectively; and the Z-axis motor 8Z, which moves the main-shaft head 6 in the Z-direction. Each of the motors 8X, 8Y, and 8Z is a servomotor. The X-axis motor 8X and the Y-axis motor 8Y are fixed to the bed 2 and are each connected to the table 3 via a ball screw (not shown). The Z-axis motor 8Z is fixed to the upper-end section of the column 16 and is connected to the main-shaft head 6 via a ball screw (not shown).

The feed-load measurement unit 9X, which measures the magnitude of the load on the X-axis motor 8X, is connected to the X-axis motor 8X. The feed-load measurement unit 9Y, which measures the magnitude of the load on the Y-axis motor 8Y, is connected to the Y-axis motor 8Y. The feed-load measurement units 9X and 9Y have, for example, current sensors for measuring the currents in the motors 8X and 8Y, respectively. The measured currents are increased as the loads applied to the motors 8X and 8Y increase. The feed-load measurement units 9X and 9Y indirectly measure the loads applied to the motors 8X and 8Y on the basis of the measured current values of the motors 8X and 8Y. The feed-load measurement units 9X and 9Y send the current values to the control device 10. The feed-load measurement units 9X and 9Y may calculate load torques from the current values and may send the load torques to the control device 10.

The control device 10 is provided with: a storage unit 11 that has a RAM, a ROM, a non-volatile memory, etc.; a control unit 12 that controls the motors 4b, 7, 8X, 8Y, and 8Z; an anomaly detection unit 13 that detects abnormal loads on the X-axis motor 8X and the Y-axis motor 8Y; and a notification unit 14 that notifies an operator of an abnormal load.

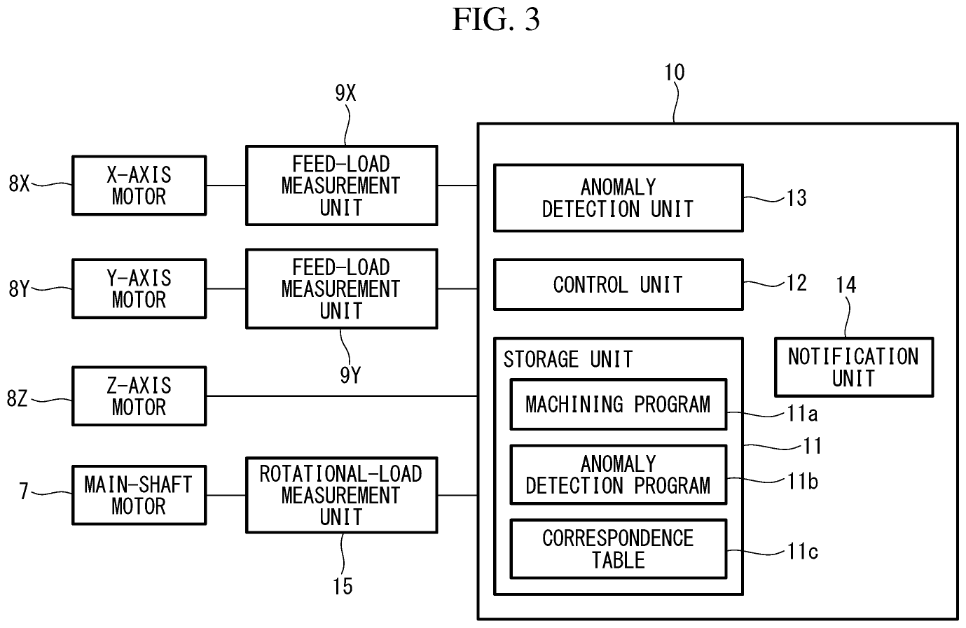

As shown in FIG. 3, the storage unit 11 has a machining program 11a, an anomaly detection program 11b, and a correspondence table 11c stored therein.

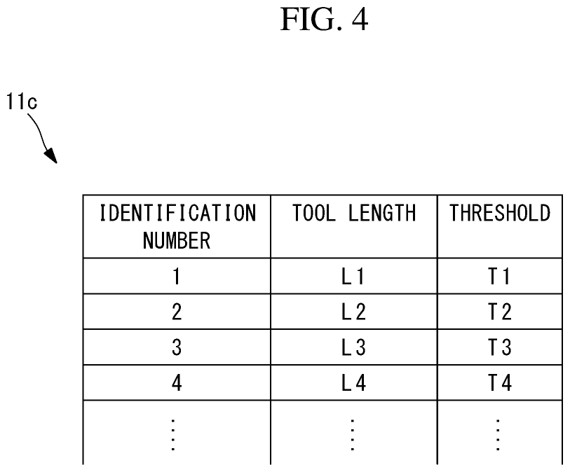

As shown in FIG. 4, in the correspondence table 11c, an identification number i (i=1, 2, 3, . . . ) of each of the tool holding parts 4a, a tool length Li that is the length of each of the tools 20, and a predetermined threshold Ti are associated with one another. The tool length Li is, for example, the length in the Z-direction from the distal end (lower end) of the tool 20 to the distal end (lower end) of the main shaft 5, in a state in which the tool 20 is held by the main shaft 5. The threshold Ti is a threshold for loads to be applied to the X-axis motor 8X and the Y-axis motor 8Y. The operator can input the tool length Li and the threshold Ti to the correspondence table 11c by using, for example, an input device connected to the control device 10. In the correspondence table 11c, the threshold Ti is reduced as the tool length Li increases.

The control unit 12 has a processor, generates control signals on the basis of the machining program 11a, and sends the control signals to the motors 4b, 7, 8X, 8Y, and 8Z. Accordingly, the motors 4b, 7, 8X, 8Y, and 8Z are operated on the basis of the machining program 11a, and replacement of the tool 20 held by the main shaft 5 and machining of the workpiece W by using the tool 20 are alternately performed.

The anomaly detection unit 13 has a processor and detects, during execution of the machining program 11a, abnormal loads on the X-axis motor 8X and the Y-axis motor 8Y on the basis of the anomaly detection program 11b and the correspondence table 11c. Specifically, the anomaly detection unit 13 obtains, from the control unit 12, the identification number i corresponding to the tool 20 that is held by the main shaft 5, reads, from the storage unit 11, the threshold Ti associated with the identification number i in the correspondence table 11c, and sets the read threshold Ti as a criterion for determining the abnormal loads. Then, the anomaly detection unit 13 receives the current values of the motors 8X and 8Y from the feed-load measurement units 9X and 9Y and compares the current values with the threshold Ti. If the current values of both of the motors 8X and 8Y are equal to or less than the threshold Ti, the anomaly detection unit 13 determines that the loads on both of the motors 8X and 8Y fall within an acceptable range and does not detect abnormal loads. On the other hand, if the current value of at least one of the motors 8X and 8Y is greater than the threshold Ti, the anomaly detection unit 13 determines that the load on at least one of the motors 8X and 8Y is an abnormal load beyond the acceptable range, and detects the abnormal load.

When the anomaly detection unit 13 detects an abnormal load, the notification unit 14 notifies the operator of the abnormal load. The notification unit 14 is, for example, an alarm that issues a warning sound or a display unit that displays a warning message.

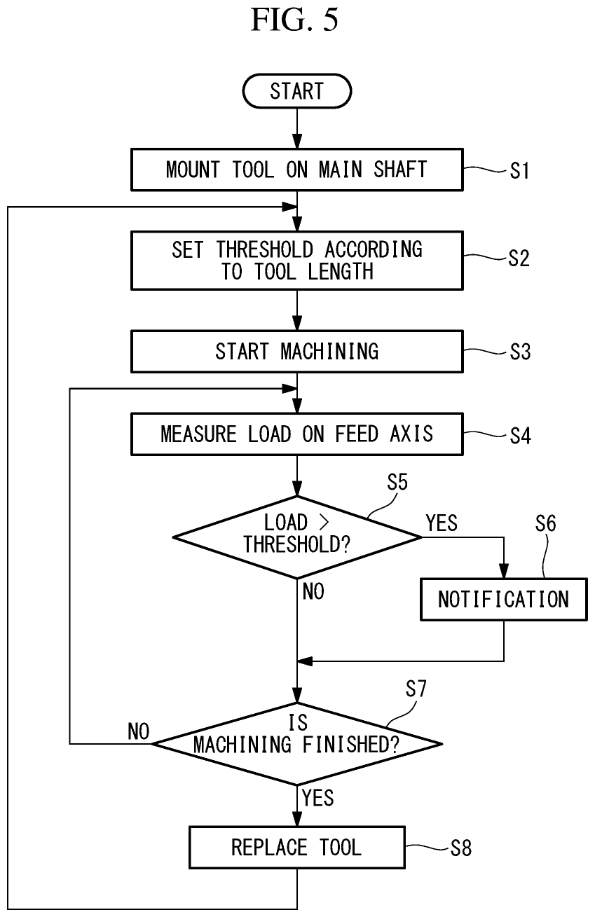

Next, the operation of the machine tool 1 will be described with reference to FIG. 5.

When the machining program 11a is started, the tool 20 that is to be first used is mounted on the main shaft 5 (Step S1).

Next, machining of the workpiece W using the tool 20 held by the main shaft 5 is started (Step S2). Specifically, the main-shaft motor 7 rotates the main shaft 5, thereby rotating the tool 20 about the longitudinal axis thereof. The Z-axis motor 8Z moves the main-shaft head 6 in the Z-direction, thereby moving the tool 20 in the Z-direction, and the X-axis motor 8X and the Y-axis motor 8Y move the table 3 in the X-direction and the Y-direction, thereby moving the workpiece W in the X-direction and the Y-direction. Accordingly, the workpiece W is machined by the distal-end section of the rotating tool 20. For example, in the case of milling, the tool 20 is made to descend to a predetermined position, and then, the workpiece W is moved in the X-direction and the Y-direction with respect to the distal-end section of the tool 20, with the tool 20 being rotated at the fixed position.

During machining of the workpiece W, loads in the directions of movement of the table 3 are applied to the X-axis motor 8X, the Y-axis motor 8Y, and the distal-end section of the tool 20, due to the contact between the distal-end section of the tool 20 and the workpiece W. The anomaly detection program is executed concurrently with the machining program, and the feed-load measurement units 9X and 9Y and the anomaly detection unit 13 monitor whether abnormal loads are applied to the motors 8X and 8Y.

Specifically, when the tool 20 is mounted on the main shaft 5 in Step S1, the anomaly detection unit 13 obtains the identification number i corresponding to the mounted tool 20 from the control unit 12, reads the threshold Ti associated with the obtained identification number i from the correspondence table 11c in the storage unit 11, and sets the read threshold Ti as the criterion for determining an abnormal load (Step S2). Then, machining is started (Step S3), and the current values, which indicate the loads on the X-axis motor 8X and the Y-axis motor 8Y, are measured by the feed-load measurement units 9X and 9Y, respectively (Step S4).

If the current values of both of the motors 8X and 8Y are equal to or less than the threshold Ti (NO in Step S5), abnormal loads on the motors 8X and 8Y are not detected, and the machining is continued. On the other hand, if the current value of at least one of the motors 8X and 8Y is greater than the threshold Ti (YES in Step S5), an abnormal load is detected, the notification unit 14 notifies the operator of the abnormal load (Step S6). The operator recognizes that the abnormal load is applied to the motor 8X and/or the motor 8Y on the basis of a warning sound or a warning message from the notification unit 14, and takes an avoidance action for avoiding damage to the motors 8X and 8Y, the main shaft 5, and the main-shaft head 6. For example, the operator stops the motors 7, 8X, 8Y, and 8Z or causes the tool 20 to retreat from the workpiece W.

After the machining of the workpiece W using the one tool 20 is finished (YES in Step S7), the tool 20 held by the main shaft 5 is replaced with another tool 20 (Step S8). In response to the replacement of the tool 20, the anomaly detection unit 13 reads, from the correspondence table 11c, the threshold Tj associated with the tool length Lj of the tool 20 mounted after the replacement and sets the read threshold Tj as the criterion for determining an abnormal load (Step S2). Accordingly, the threshold for the loads on the motors 8X and 8Y is changed to the threshold Tj associated with the tool length Lj.

Then, machining of the workpiece W using the tool 20 mounted after the replacement is started (Step S3), and abnormal loads on the motors 8X and 8Y are monitored on the basis of the threshold Tj set after the change (Steps S4 to S6).

In this way, according to this embodiment, every time the tool 20 held by the main shaft 5 is replaced, the anomaly detection unit 13 changes the threshold used to determinate an abnormal load, in accordance with the tool length of the tool 20 mounted after the replacement. At this time, the value of the threshold is reduced as the tool length of the tool 20 mounted after the replacement increases.

Even though the loads on the feed-axis motors 8X and 8Y stay the same, the load applied to the main shaft 5 differs depending on the tool length. Specifically, the load (moment) applied to the main shaft 5, which holds the proximal-end section of the tool 20, is increased as the tool length increases. Therefore, it is difficult to accurately determine the magnitude of the load applied to the main shaft 5 on the basis of only the magnitudes of the loads on the feed-axis motors 8X and 8Y.

According to this embodiment, as described above, the threshold is changed in accordance with the tool length. Accordingly, it is possible to set an appropriate threshold for each tool 20 to be used, so as to detect an abnormal load(s) on the feed-axis motor 8X and/or the feed-axis motor 8Y before an excessive load is applied to the main shaft 5. Accordingly, it is possible to notify the operator of the abnormal loads on the feed-axis motors 8X and 8Y before the main shaft 5 and the main-shaft head 6 are damaged, thus preventing damage to the main shaft 5 and the main-shaft head 6.

FIG. 6 is a longitudinal sectional view of the main shaft 5 and the main-shaft head 6. Reference sign 17 denotes a tool holding member that is disposed inside the main shaft 5 and that holds the proximal-end section of the tool 20. The bearing parts 6a and 6b each have, for example, two angular contact ball bearings. In the configuration in which the main shaft 5 is supported by the bearing parts 6a and 6b, when a load in an XY-direction perpendicular to the longitudinal axis of the tool 20 is applied to the distal-end section of the tool 20, the load is mainly applied to the bearing parts 6a and 6b. Thus, the bearing parts 6a and 6b are particularly subject to damage. When the bearing parts 6a and 6b are damaged, the main shaft 5 and the tool 20 become unable to be normally rotated, and the main shaft 5 and the tool 20 are vibrated, thus significantly affecting the machining accuracy of the workpiece W. Loads applied to the bearing parts 6a and 6b when the load in the XY-direction is applied to the distal-end section of the tool 20 depend on the distances in the Z-direction from the distal end of the tool 20 to the bearing parts 6a and 6b. Therefore, the threshold Ti is set on the basis of the distances in the Z-direction from the distal end of the tool 20 to the bearing parts 6a and 6b, such that the magnitudes of the loads applied to the bearing parts 6a and 6b become equal to or less than a predetermined value.

As shown in FIG. 6, in a case in which the main shaft 5 is supported by the bearing parts 6a and 6b at two positions with a space therebetween in the longitudinal direction, a larger load is applied to the distal-end (lower-side) bearing part 6b, which is close to the distal-end section of the tool 20, than that applied to the proximal-end (upper-side) bearing part 6a, which is far from the distal-end section of the tool 20. The load applied to the distal-end bearing part 6b depends on, in addition to the tool length, the space between the bearing parts 6a and 6b in the Z-direction, and the distance from the distal end of the main shaft 5 to the proximal-end bearing part 6a. Therefore, the threshold Ti is set on the basis of the tool length Li, the space between the bearing parts 6a and 6b in the Z-direction, and the distance from the distal end of the main shaft 5 to the bearing part 6a.

Specifically, a load fb applied to the bearing part 6b when a load f in the XY-direction is applied to the distal end of the tool 20 is expressed by the following expression (a).

Fb=(Xa+L)f/(Xa−Xb) (a)

As shown in FIG. 7, L indicates the length of the tool 20 in the Z-direction from the distal end of the tool 20 to the distal end of the main shaft 5. Xa indicates the distance in the Z-direction from the distal end of the main shaft 5 to the proximal-end bearing part 6a. Xb indicates the distance in the Z-direction from the distal end of the main shaft 5 to the distal-end bearing part 6b.

In order for the load fb of the bearing part 6b to be equal to or less than a permissible load Fmax of the bearing part 6b, the maximum value fmax of the load f satisfies the following expression (b).

f max=(Xa−Xb)F max/(Xa+L) (b)

The expression (b) can be rewritten with the following expression (1) by using design values A and B of the main shaft 5 and the bearing parts 6a and 6b. The magnitudes of the loads (currents) on one of the feed-axis motors 8X and 8Y when the load fmax is applied to the distal end of the tool 20 are set to the threshold Ti.

$$\begin{matrix}\{ Formula 2 \} & \\ f max = \frac{1}{A + LB} \\ A = \frac{X a}{( X a - X b ) F max} \\ B = \frac{1}{( X a - X b ) F max} & ( 1 )\end{matrix}$$

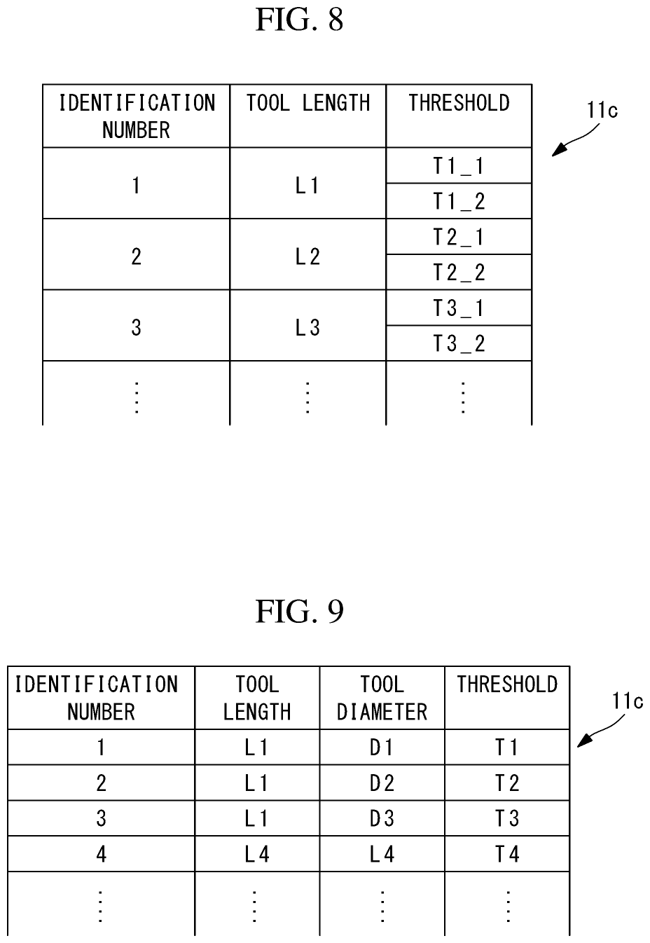

In this embodiment, as shown in FIG. 8, two thresholds Ti_1 and Ti_2 (i=1, 2, 3, . . . ) may also be set for each tool length. The second threshold Ti_2 is larger than the first threshold Ti_1.

The anomaly detection unit 13 detects an abnormal load when the current value of at least one of the motors 8X and 8Y is greater than the first threshold Ti_1. If an abnormal load is detected, the anomaly detection unit 13 compares the current value(s) of the motor 8X and/or the motor 8Y with the second threshold Ti_2.

If the current value is greater than the first threshold Ti_1 and is equal to or less than the second threshold Ti_2, the notification unit 14 displays a warning message. If the current value is greater than the second threshold Ti_2, the notification unit 14 issues a warning sound, and the control unit 12 stops the motors 7, 8X, 8Y, and 8Z.

According to this configuration, if an abnormal load(s) applied to the feed-axis motor 8X and/or the feed-axis motor 8Y is/are relatively small, a warning message is displayed. Thereafter, when the abnormal load(s) applied to the feed-axis motor 8X and/or the feed-axis motor 8Y is/are further increased, and the current value(s) is/are greater than the second threshold Ti_2, a warning sound is issued, and the motors 7, 8X, 8Y, and 8Z are automatically stopped. In this way, it is possible to make the operator recognize the magnitude(s) of the abnormal load(s) on the feed-axis motor 8X and/or the feed-axis motor 8Y, in two stages.

In this embodiment, the threshold may also be changed according to a tool diameter D in addition to the tool length. As shown in FIG. 7, the diameter of a typical tool 20 is less at the distal end than at the proximal end. The tool diameter D is the outer diameter of the distal-end section of the tool 20.

For example, as shown in FIG. 9, in the correspondence table 11c, the identification number i, the tool length Li, the tool diameter Di, and the threshold Ti are associated with one another. In the example shown in FIG. 9, tools having the identification numbers 1, 2, and 3 have the same tool length, tool diameters (D1<D2<D3) that are different from one another, and thresholds (T1<T2<T3) that are different from one another. In this way, the threshold Ti is reduced as the tool diameter Di decreases.

As the tool diameter D decreases, the tool 20 weakens to a load in the radial direction of the tool 20. Therefore, if the same threshold as that for a thick tool 20 is used for a thin tool 20, there is a possibility that an abnormality, such as damage, occurs in the thin tool 20 before an abnormal load(s) is/are applied to the feed-axis motor 8X and/or the feed-axis motor 8Y. By changing the threshold Ti in accordance with the tool diameter Di, the occurrence of an abnormality in the thin tool 20 can be prevented.

In this embodiment, the anomaly detection unit 13 may also detect an abnormal load(s) on the feed-axis motor 8X and/or the feed-axis motor 8Y in consideration with a load applied to the main-shaft motor 7.

In this case, as shown in FIG. 3, a rotational-load measurement unit 15 that measures the magnitude of the load on the main-shaft motor 7 is provided. The rotational-load measurement unit 15 indirectly measures the load applied to the main-shaft motor 7 on the basis of the current value of the main-shaft motor 7, for example, as in the feed-load measurement units 9X and 9Y. The rotational-load measurement unit 15 may also calculate a load torque from the current.

The anomaly detection unit 13 receives the current value of the main-shaft motor 7 from the rotational-load measurement unit 15 and changes the threshold Ti according to the current value of the main-shaft motor 7. The threshold Ti is reduced as the current value of the main-shaft motor 7 decreases.

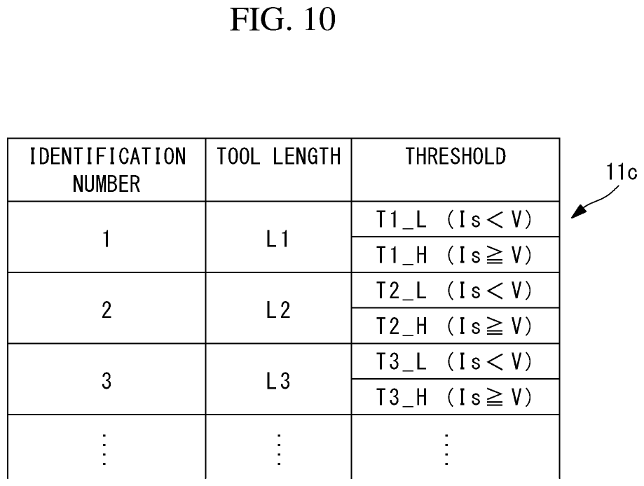

For example, as shown in FIG. 10, a threshold Ti_L (i=1, 2, 3, . . . ) is set when a current value Is of the main-shaft motor 7 is equal to or less than a predetermined value V, and a threshold Ti_H (i=1, 2, 3, . . . ) is set when the current value Is of the main-shaft motor 7 is greater than the predetermined value V. The threshold Ti_L is lower than the threshold Ti_H. In this example case, the threshold Ti is changed in two stages according to the current value of the main-shaft motor 7.

The threshold Ti may also be changed in three or more stages or continuously changed.

When no load or almost no load is applied to the main-shaft motor 7 even though loads are applied to the X-axis motor 8X and the Y-axis motor 8Y, there is a possibility that the workpiece W is not transferred to the position of the tool 20 because movement of the workpiece W or the table 3 is prevented by a peripheral object, or for another reason, and the tool 20 is rotated without being in contact with the workpiece W.

With the magnitude of the load on the main-shaft motor 7 being taken into consideration, it is possible to detect that abnormal loads are applied to the motors 8X and 8Y, the abnormal loads being caused by contact between the table 3 or the workpiece W and an object other than the tool 20. In particular, by reducing the threshold Ti as the load on the main-shaft motor 7 decreases, it is possible to sensitively detect such abnormal loads.

In this embodiment, although the table 3 is moved in the X-direction and the Y-direction, instead of this, it is also possible to configure the main shaft 5 to be moved in the X-direction and the Y-direction. Alternatively, it is also possible to configure both of the table 3 and the main shaft 5 to be moved in the X-direction and the Y-direction. The table 3 and the main shaft 5 may also be configured to be relatively moved only in one of the X-direction and the Y-direction.

In this embodiment, although the main-shaft head 6, the main shaft 5, and the tool 20, which is held by the main shaft 5, are disposed along the vertical direction, instead of this, it is also possible to dispose them in the horizontal direction. For example, when the main-shaft head 6, the main shaft 5, and the tool 20 are disposed in the X-direction, the table 3 and the main shaft 5 are configured to be relatively moved in at least one of the Y-direction and the Z-direction.

In this embodiment, although the threshold Ti is held in advance in the storage unit 11, instead of this, the anomaly detection unit 13 may calculate the threshold Ti from the tool length Li.

For example, the anomaly detection unit 13 holds a function that represents the relationship between the tool length Li and the threshold Ti. Every time the tool 20 held by the main shaft 5 is replaced, the anomaly detection unit 13 calculates the threshold Ti from the function by using the tool length Li of the tool 20 held after the replacement and uses the calculated threshold Ti to detect an abnormal load.

As a result, the following aspect is derived from the above described embodiment.

According to one aspect, the present invention provides a machine tool including: a main shaft that holds a tool; a feed-axis motor that relatively moves a table to which a workpiece is fixed and the main shaft, in a direction intersecting the longitudinal axis of the main shaft; a feed-load measurement unit that measures the magnitude of a load applied to the feed-axis motor; and an anomaly detection unit that detects an abnormal load on the feed-axis motor when the magnitude of the load measured by the feed-load measurement unit is greater than a predetermined threshold, wherein the predetermined threshold is changed according to the length of a tool that is held by the main shaft.

According to this aspect, the feed-axis motor relatively moves the main shaft and the table, thereby relatively moving the tool, which is held by the main shaft, and the workpiece, which is fixed to the table, and the workpiece is machined by the distal-end section of the tool. Because the tool and the workpiece are relatively moved while being in contact with each other during the machining of the workpiece, a load in the direction of the relative movement is applied to the feed-axis motor and the main shaft. The load on the feed-axis motor is measured by the feed-load measurement unit, and, when an abnormal load greater than the predetermined threshold is applied to the feed-axis motor, the abnormal load is detected by the anomaly detection unit.

The load on the main shaft is increased as the load on the feed-axis motor increases. Therefore, it is also possible to detect that a large load is applied to the main shaft on the basis of detection of the abnormal load on the feed-axis motor. In this case, the load applied to the main shaft differs depending on the length of the tool. According to this aspect, the threshold is changed according to the length of the tool to be used for machining. Therefore, an appropriate threshold can be set for each tool to be used, so as to prevent a large load from being excessively applied to the main shaft.

In the above-described aspect, it is preferred that the predetermined threshold be reduced as the tool, which is held by the main shaft, becomes longer.

The load applied to the main shaft is increased as the tool becomes longer. Therefore, by reducing the threshold as the tool becomes longer, it is possible to reduce variation in the maximum load applied to the main shaft.

The above-described aspect may further include a storage unit that stores a correspondence table in which the length of the tool and the predetermined threshold are associated with each other. Alternatively, the anomaly detection unit may calculate the predetermined threshold from the length of the tool.

The above-described aspect may further include two bearing parts that are disposed with a space therebetween in the direction along the longitudinal axis of the main shaft and that support the main shaft in a manner allowing the main shaft to rotate about the longitudinal axis of the main shaft, wherein the predetermined threshold may be set on the basis of the length of the tool, the space between the two bearing parts, and the distance from the distal end of the main shaft to the bearing part that is disposed close to a proximal end.

In the configuration in which the main shaft is supported by the two bearing parts, a larger load is applied to the bearing part that is close to the distal end. The load applied to the bearing part that is close to the distal end depends on, in addition to the length of the tool, the space between the two bearing parts and the distance from the distal end of the main shaft to the bearing part that is close to the proximal end. Therefore, according to the above-described configuration, the threshold can be set so as to prevent a large load from being excessively applied to the bearing part.

In the above-described aspect, the predetermined threshold may be set on the basis of a load fmax defined by the following expression (1);

$$\begin{matrix}\{ Expression 1 \} & \\ f max = \frac{1}{A + LB} \\ A = \frac{X a}{( X a - X b ) F max} \\ B = \frac{1}{( X a - X b ) F max} & ( 1 )\end{matrix}$$

where, Fmax indicates a permissible load on the bearing parts, fmax indicates a load applied to a distal end of the tool when the permissible load is applied to the bearing parts, L indicates the length of the tool, which is the length from the distal end of the tool to the distal end of the main shaft, Xa indicates the distance from the distal end of the main shaft to the bearing part that is disposed close to the proximal end, and Xb indicates the distance from the distal end of the main shaft to the bearing part that is disposed close to the distal end.

As described above, among the two bearing parts, a larger load is applied to the bearing part that is close to the distal end. According to the above-described configuration, the threshold can be set such that the load applied to the bearing part that is close to the distal end becomes equal to or less than the permissible load Fmax.

In the above-described aspect, the predetermined threshold may be changed according to the diameter of the tool, which is held by the main shaft; and the predetermined threshold may be reduced as the diameter of the tool, which is held by the main shaft, becomes smaller.

The tool weakens to a force in the radial direction of the tool as the diameter of the tool becomes smaller. By reducing the threshold as the diameter of the tool becomes smaller, it is possible to prevent damage to the tool.

The above-described aspect may further include: a main-shaft motor that rotates the main shaft about the longitudinal axis of the main shaft; and a rotational-load measurement unit that measures the magnitude of a load applied to the main-shaft motor, wherein the anomaly detection unit may change the predetermined threshold on the basis of the length of the tool and the magnitude of the load on the main-shaft motor measured by the rotational-load measurement unit.

According to this configuration, from the relationship between the load on the feed-axis motor and the load on the main-shaft motor, it is possible to find an abnormality of the main-shaft motor or the tool, for example, rotation of the tool without involving contact or a rotation error of the main shaft. By changing the threshold according to the load on the main-shaft motor, it is possible to quickly detect an abnormality of the main-shaft motor or the tool.

In the above-described aspect, the predetermined threshold may be reduced as the load on the main-shaft motor becomes smaller.

When the tool is rotated without being in contact with the workpiece, the load on the main shaft is small. Therefore, by reducing the predetermined threshold as the load on the main-shaft motor becomes smaller, it is possible to more sensitively detect that a load from an object other than the tool is applied to the feed-axis motor.

The above-described aspect may further include a notification unit that notifies an operator of the abnormal load when the abnormal load is detected by the anomaly detection unit.

According to this configuration, with a notification issued by the notification unit, it is possible to make an operator recognize an abnormal load on the feed-axis motor.

The above-described aspect may further include a control unit that controls the feed-axis motor, wherein the predetermined threshold may include a first threshold and a second threshold that is larger than the first threshold; the notification unit may display a warning message when the magnitude of the measured load is greater than the first threshold and is equal to or less than the second threshold; and the control unit may stop the feed-axis motor when the magnitude of the measured load is greater than the second threshold.

According to this configuration, when an abnormal load on the feed-axis motor is relatively small, the operator is informed of the abnormal load by a warning message. Then, when the abnormal load on the feed-axis motor is further increased, the control unit forcibly stops the feed-axis motor. In this way, the operator can recognize the magnitude of the abnormal load, in two stages.

### REFERENCE SIGNS LIST

1 machine tool
2 bed
3 table
4 tool magazine
4a tool holding part
5 main shaft
6 main-shaft head
6a, 6b bearing part
7 main-shaft motor
8X, 8Y, 8Z feed-axis motor
9X, 9Y feed-load measurement unit
10 control device
11 storage unit
11a machining program
11b anomaly detection program
11c correspondence table
12 control unit
13 anomaly detection unit
14 notification unit
15 rotational-load measurement unit
16 column
17 tool holding member
20 tool
W workpiece

1. A machine tool comprising:
a main shaft that holds a tool;
a feed-axis motor that relatively moves a table to which a workpiece is fixed and the main shaft, in a direction intersecting the longitudinal axis of the main shaft;
a feed-load measurement unit that measures the magnitude of a load applied to the feed-axis motor;
an anomaly detection unit that detects an abnormal load on the feed-axis motor when the magnitude of the load measured by the feed-load measurement unit is greater than a predetermined threshold; and
wherein the predetermined threshold is changed according to the length of a tool that is held by the main shaft.

2. The machine tool according to claim 1, wherein the predetermined threshold is reduced as the tool, which is held by the main shaft, becomes longer.

3. The machine tool according to claim 1, further comprising a storage unit that stores a correspondence table in which the length of the tool and the predetermined threshold are associated with each other.

4. The machine tool according to claim 1, wherein the anomaly detection unit calculates the predetermined threshold from the length of the tool, which is held by the main shaft.

5. The machine tool according to claim 1, further comprising:
two bearing parts that are disposed with a space therebetween in the direction along the longitudinal axis of the main shaft and that support the main shaft in a manner allowing the main shaft to rotate about the longitudinal axis of the main shaft; and
wherein the predetermined threshold is set on the basis of the length of the tool, the space between the two bearing parts, and the distance from the distal end of the main shaft to the bearing part that is disposed close to a proximal end.

6. The machine tool according to claim 5, wherein the predetermined threshold is set on the basis of a load fmax defined by the following expression (1);
$$\begin{matrix}\{ Expression 1 \} & \\ f max = \frac{1}{A + LB} \\ A = \frac{X a}{( X a - X b ) F max} \\ B = \frac{1}{( X a - X b ) F max} & ( 1 )\end{matrix}$$
where:
Fmax indicates a permissible load on the bearing parts;
fmax indicates a load applied to a distal end of the tool when the permissible load is applied to the bearing parts;
L indicates the length of the tool, which is the length from the distal end of the tool to the distal end of the main shaft;
Xa indicates the distance from the distal end of the main shaft to the bearing part that is disposed close to the proximal end, in the direction along the longitudinal axis of the main shaft; and
Xb indicates the distance from the distal end of the main shaft to the bearing part that is disposed close to the distal end, in the direction along the longitudinal axis of the main shaft.

7. The machine tool according to claim 1,
wherein the predetermined threshold is changed according to the diameter of the tool, which is held by the main shaft; and
wherein the predetermined threshold is reduced as the diameter of the tool, which is held by the main shaft, becomes smaller.

8. The machine tool according to claim 1, further comprising:
a main-shaft motor that rotates the main shaft about the longitudinal axis of the main shaft;
a rotational-load measurement unit that measures the magnitude of a load applied to the main-shaft motor; and
wherein the anomaly detection unit changes the predetermined threshold on the basis of the length of the tool and the magnitude of the load on the main-shaft motor measured by the rotational-load measurement unit.

9. The machine tool according to claim 8, wherein the predetermined threshold is reduced as the load on the main-shaft motor becomes smaller.

10. The machine tool according to claim 1, further comprising a notification unit that notifies an operator of the abnormal load when the abnormal load is detected by the anomaly detection unit.

11. The machine tool according to claim 10, further comprising:
a control unit that controls the feed-axis motor;
wherein the predetermined threshold includes a first threshold and a second threshold that is larger than the first threshold;
wherein the notification unit displays a warning message when the magnitude of the measured load is greater than the first threshold and is equal to or less than the second threshold; and
wherein the control unit stops the feed-axis motor when the magnitude of the measured load is greater than the second threshold.
